(19) United States
(12) Patent Application Publication
(10) Pub. No.: US 2008/0111933 A1
(43) Pub. Date: May 15, 2008

(54) Display Device

(76) Inventors: Young-wook LEE, Suwon-si (KR); Woo-geun Lee, Yongin-si (KR); Kyung-sook Jeon, Incheon (KR); Youn-hee Cha, Hwaseong-si (KR); Jong-in Kim, Yongin-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/868,865

(22) Filed: Oct. 8, 2007

(30) Foreign Application Priority Data
Nov. 13, 2006 (KR) 10-2006-0111707

(51) Int. Cl. G02F 1/1343

(52) U.S. Cl. 349/38

(57) ABSTRACT

A display device includes a gate line delivering a gate on/off voltage, a data line insulated to the gate line, a pixel transistor including a gate electrode connected to the gate line, a drain electrode connected to the data line and a source electrode spaced apart with the drain electrode, a pixel electrode connected to the source electrode, a dummy gate line delivering a kick-back compensation voltage complimentary to the gate on/off voltage, and a compensation capacitance formed between a dummy gate electrode connected to the dummy gate line and a dummy source electrode connected to the pixel electrode.

The present invention claims Paris Convention priority of South Korean patent application No. 10-2006-0111707 filed on Nov. 13, 2006, incorporated herein by reference.

### BACKGROUND OF THE INVENTION

(a) Field of the Invention

The present invention relates to a display device, and in particular, to a display having high image quality.

(b) Description of Related Art

A liquid crystal display (LCD) is one of the most widely used flat panel display types. An LCD includes two panels provided with field-generating electrodes such as pixel electrodes and a common electrode, and a liquid crystal (LC) layer interposed therebetween. The LCD displays images by applying voltages to the field-generating electrodes to generate an electric field in the LC layer, which determines orientations of LC molecules in the LC layer to adjust polarization of incident light.

Switching elements, such as thin film transistors, are used to apply voltages to the pixel electrodes switching elements. When a gate-on voltage is applied to gate electrodes of the transistors, the transistors are turned on and supply voltages for images to the pixel electrodes through source electrodes of the transistors. When a gate-off voltage is applied to the gate electrodes, the transistors are turned off and the pixel electrodes maintain the applied voltages.

However, the source electrodes overlap over the gate electrodes and parasite capacitances exist between the source electrodes, so that a “kick-back” phenomenon occurs when the gate-on voltage changes into the gate-off voltage. The kick-back phenomenon gives rise to an abrupt drop-down of voltage levels maintained in the pixel electrodes, and produces bad effects on the displaying images.

### SUMMARY OF THE INVENTION

In accordance with an embodiment of the present invention, a display device includes a gate line delivering a gate on/off voltage, a data line insulated to the gate line, a pixel transistor including a gate electrode connected to the gate line, a drain electrode connected to the data line and a source electrode spaced apart with the drain electrode, a pixel electrode connected to the source electrode, a dummy gate line delivering a kick-back compensation voltage complimentary to the gate on/off voltage, and a compensation capacitance formed between a dummy gate electrode connected to the dummy gate line and a dummy source electrode connected to the pixel electrode. The compensation capacitance is substantially the same as a parasite capacitance formed between the source electrode and the gate electrode.

In accordance with another embodiment of the invention, overlap area of the dummy source electrode and the dummy gate electrode is substantially the same as an overlap area of the source electrode and the gate electrode. The source electrode extends over the gate electrode to a first direction and the dummy source electrode extends over the dummy gate electrode to the first direction.

In accordance with still another embodiment of the invention, the source electrode extends from outside to the drain electrode through opposing two sides of the gate electrode and the dummy source electrode extends from outside to inside through opposing two sides of the dummy gate electrode. Overlap area of the dummy source electrode and the dummy gate electrode is substantially the same as an overlap area of the source electrode and the gate electrode.

### BRIEF DESCRIPTION OF THE DRAWINGS

FIG. 1 is a block diagram according to an embodiment of the present invention.

FIG. 2 is a circuit diagram of a pixel in FIG. 1.

FIG. 3 is a timing diagram for explaining the operation of a kick-back compensation voltage generator in FIG. 1.

FIG. 4 is a circuit diagram to explain a kick-back compensation voltage supplier 601 according to an embodiment of the present invention.

FIG. 5 is a circuit diagram to explain a kick-back compensation voltage supplier 602 according to another embodiment of the present invention.

FIG. 6 is a circuit diagram to explain a kick-back compensation voltage supplier 603 according to another embodiment of the present invention.

FIG. 7A is a circuit diagram to explain a kick-back compensation voltage supplier 604 according to another embodiment of the present invention and FIG.

7B is a timing diagram to explain the kick-back compensation voltage supplier 604 in FIG. 7A

FIG. 7C is a table to explain the operation of the kick-back compensation voltage supplier 604 in FIG. 7A.

FIG. 8A is a layout for explaining a first substrate 101 of an LCD according to another embodiment of the present invention

FIG. 8B is a sectional view taken along VIIb-VIIb′ of FIG. 8A.

FIG. 8C is a sectional view taken along VIIc-VIIc′ of FIG. 8A.

FIG. 8D is an enlarged view of the areas A and B of FIG. 8A.

FIG. 9A is a layout for explaining a first substrate 102 of an LCD according to another embodiment of the present invention.

FIG. 9B is an enlarged view of the areas C and D of FIG. 9A.

FIG. 10A is a layout for explaining a first substrate 103 of an LCD according to another embodiment of the present invention.

FIG. 10B is an enlarged view of the areas E and F of FIG. 10A.

Use of the same reference symbols in different figures indicates similar or identical items.

### DETAILED DESCRIPTION OF EMBODIMENTS

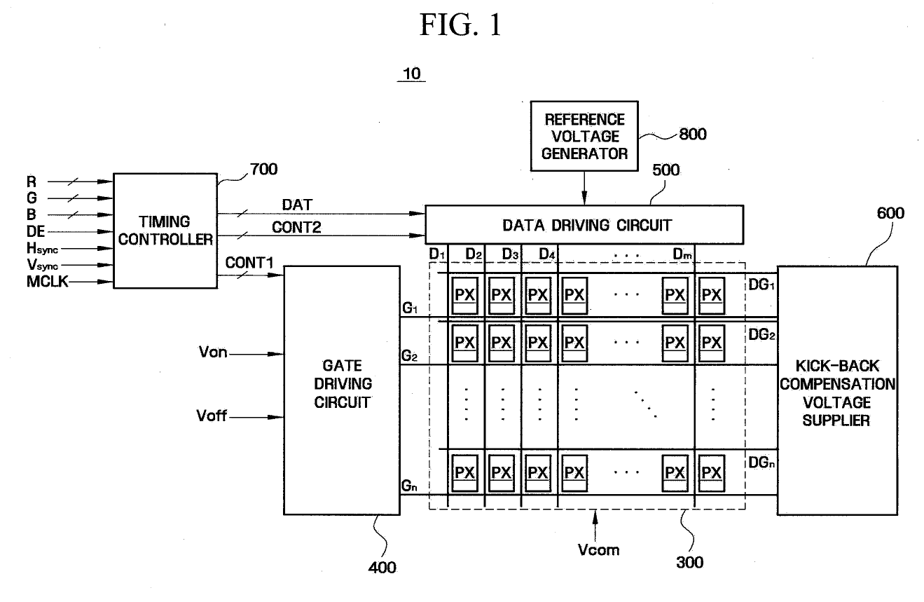

An LCD device according to an embodiment of the present invention will be explained with reference to FIGS. 1-3.

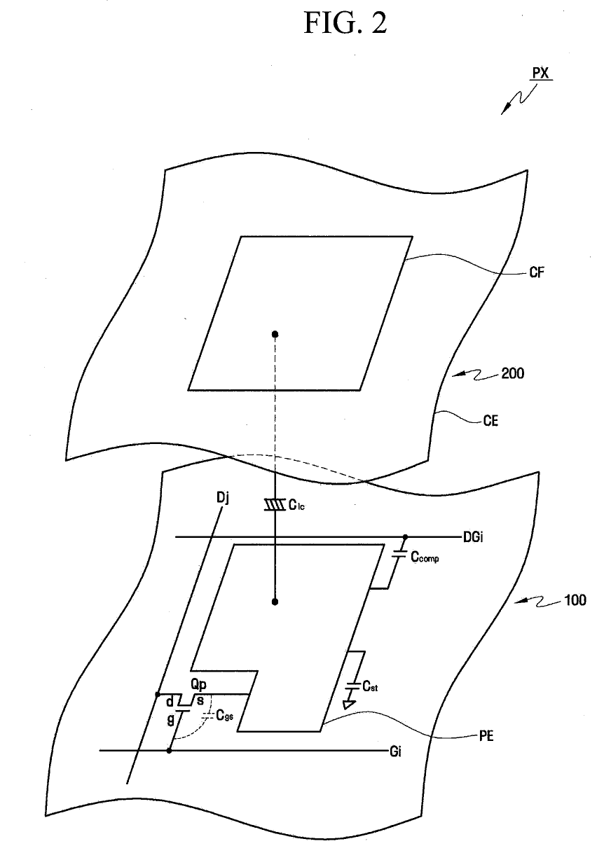

FIG. 1 is a block diagram according to an embodiment of the present invention and FIG. 2 is a circuit diagram of a pixel PX in FIG. 1.

The LCD device of FIG. 1 includes a display portion 300, a gate driving circuit 400, a data driving circuit 500, a kick-back compensation voltage supplier 600, a timing controller 700 and a reference voltage generator.

The display portion 300 includes a plurality of signal lines G1-Gn and D1-Dm, and a plurality of pixels PX connected to the signal lines G1-Gn and D1-Dm.

The signal lines G1-Gn and D1-Dm includes a plurality of gate lines G1-Gn for delivering gate on/off voltages Von/Voff, and a plurality of data lines D1-Dm for delivering video data voltages.

The display part 300 also includes a plurality of dummy gate lines DG1-DGn for delivering kick-back compensation voltages. Each of the dummy gate lines DG1-DGn matches each of the gate lines G1-Gn, respectively.

The display part 300, as shown by FIG. 2, includes a first substrate 100, a second substrate 200 opposite to the first substrate 100, and liquid crystal layers interposed between the first substrate 100 and the second substrate 200.

The pixel PX connected to the ith (i=1, 2, . . . , n) gate line Gi and the jth (j=1, 2, . . . , m) data line Dj, includes a pixel transistor Qp, a liquid crystal capacitance Clc, a storage capacitance Cst. The storage capacitance Cst may be omitted according to circumstances.

The pixel transistor Qp includes a drain electrode d connected to the data line Dj, a gate electrode g connected to the gate line Gi, and a source electrode s connected to a pixel electrode PE.

The liquid crystal capacitance Clc is formed between the pixel electrode PE connected to the source electrode, where video data voltages are applied through the source electrode, and a common electrode CE where a common voltage Vcom is applied.

A voltage difference between the pixel electrode PE and the common electrode CE induce the liquid crystal layers to be tilted for displaying a part of an image.

A compensation capacitance Ccomp is formed between a first electrode connected to the dummy gate line DGi and a second electrode connected to the pixel electrode PE.

The compensation capacitance Ccomp may be substantially the same as a parasite capacitance Cgs formed between the gate electrode g and the source electrode s.

The gate driving circuit 400 of FIG. 1 supplies the gate on/off voltage Von/Voff to the gate lines G1-Gn, based on a gate control signal CONT1. The gate control signal CONT1 for controlling operation of the gate driving circuit 400 includes a vertical start signal for starting operation of the gate driving circuit 400, a gate clock signal for determining an output timing of the gate-on voltage Von, and an enable signal for determining a pulse width of the gate-on voltage Von.

The data driving circuit 500 of FIG. 1, based on a data control signal CONT2 for controlling operation of the data driving circuit 500, converts a video data signal to one of the reference voltages generated from the reference voltage generator 800, and supplies it to the data line Dj. The data control signal CONT2 includes a horizontal start signal for starting operation of the driving circuit 500, and a load signal to indicate the output of two data voltages.

The kick-back compensation voltage supplier 600 of FIG. 1 is connected to the gate lines G1-Gn and the dummy gate lines DG1-DGn, and supplies a kick-back compensation voltage complementary to the gate on/off voltage Von/Voff to each dummy gate line DG1-DGn. The kick-back compensation voltage supplier 600 may operate after receiving the gate on/off voltage Von/Voff from outside.

As shown by FIG. 1, the kick-back compensation voltage supplier 600 is opposite the gate driving circuit 400 across the display part 300. However, the kick-back compensation voltage supplier 600 may be arranged on the same side with the gate driving circuit 400. Further, the kick-back compensation voltage supplier 600 may be incorporated with the gate driving circuit 400.

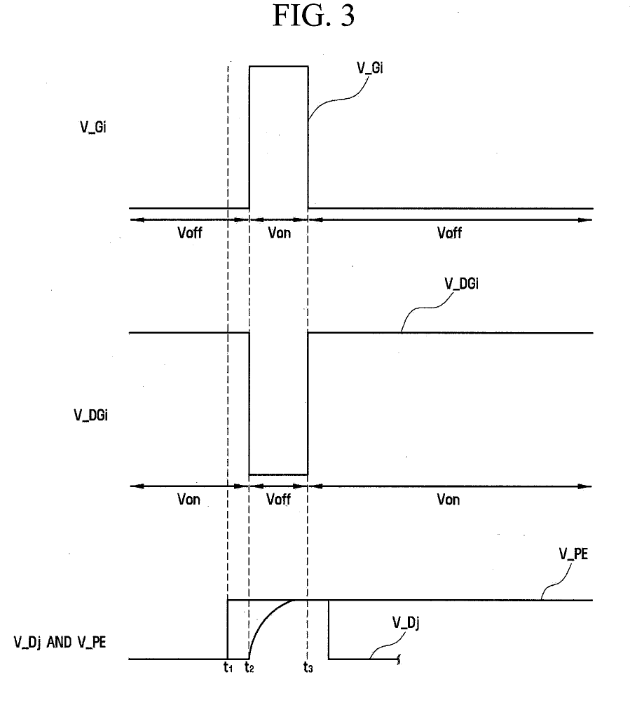

The kick-back compensation voltage supplier 600 will be explained in detail with reference to FIGS. 2 and 3. FIG. 3 is a timing diagram for explaining operation of the kick-back compensation voltage supplier 600 in FIG. 1.

Before t1, the gate-off voltage Voff is applied to the gate line Gi, and the pixel transistor Qp is turned off. At this time, a kick-back compensation voltage V_DGi complementary to the gate on/off voltage Von/Voff is applied to the dummy gate line DGi. That is, the gate-on voltage Von complimentary to the gate-off voltage Voff is applied to the dummy gate line DGi.

Next, a video data voltage is applied to the data line Dj at t1, and the gate-on voltage Von is applied to the gate line Gi at t2. When the gate-on voltage Von is applied, the pixel transistor Qp is turned on, and the video data voltage is applied to the pixel electrode PE through the data line Dj. At this time, the gate-off voltage Voff is applied to the dummy gate line DGi.

Next, when the gate-off voltage Voff is applied to the gate line Gi at t3, the pixel transistor Qp is turned off and voltage level V_Gi of the gate line Gi drops to the level difference between the gate-on voltage Von and the gate-off voltage Voff. At this time, the parasite capacitance Cgs formed between the gate electrode and the source electrode tends to draw down voltage level V_PE of the pixel electrode PE (that is, “kick-back” phenomenon).

However, when the gate-on voltage Von is applied to the dummy gate line DGi at t3, voltage level V_DGi of the dummy gate line DGi rises up as much as the level difference between the gate-on voltage Von and the gate-off voltage Voff. At this time, the compensation capacitance Ccomp formed between the dummy gate line DGi and the pixel electrode PE tends to boost up voltage level V_PE of the pixel electrode PE.

Consequently, the decrement of voltage level V_PE of the pixel electrode PE caused by the parasite capacitance Cgs is compensated with the increment of voltage level V_PE of the pixel electrode PE caused by the compensation capacitance Ccomp, so that voltage level V_PE of the pixel electrode PE could be kept stable without or minimizing occurrence of kick-back phenomenon. The compensation capacitance Ccomp may be the same as the parasitic capacitance Cgs.

The compensation principle mentioned above will be explained in detail with reference to the below Equations 1-4.

First, at a time just before t3, when voltage level V_Gi of the gate line Gi is about to change from the gate-off voltage Voff to the gate-on voltage Von, if the charge quantity of the pixel electrode PE is Qon, then Qon is calculated by the Equation 1 below.

Qon=(V_{—}PE′−Vcom)×(Clc+Cst)+(V_{—}PE′−Voff)×Ccomp+(V_{—}PE′−Von)×Cgs Equation 1

Wherein V_PE′ is a voltage level of the pixel electrode PE at the time just before t3, Clc is the liquid crystal capacitance, Cst is the storage capacitance, Ccomp is the compensation capacitance, and Cgs is the parasite capacitance.

Next, at a time right after t3, when voltage level V_Gi of the gate line Gi has changed from the gate-on voltage Von to the gate-off voltage Voff, if charge quantity of the pixel electrode PE is Qoff, then Qoff is calculated by the Equation 2 below.

Qoff=(V_{—}PE″−Vcom)×(Clc+Cst)+(V_{—}PE″−Von)×Ccomp+(V_{—}PE″−Voff)×Cgs Equation 2

Wherein V_PE″ is the voltage level of the pixel electrode PE at the time just before t3.

Equation 3 below represents the principle of charge conservation.

Qon=Qoff Equation 3

If the results of Equation 1 and 2 are substituted for Qon and Qoff of Equation 3 and some manipulations are performed, voltage level difference of the pixel electrode PE before and after t3 will be expressed by Equation 4 below.

V_{—}PE′−V_{—}PE″={(Von−Voff)×(Cgs−Ccomp}/(Clc+Cst+Ccomp+Cgs) Equation 4

The left term of Equation 4 represents voltage level difference of the pixel electrode PE before and after t3, and the voltage level difference is proportional to the term (Cgs−Ccomp).

However, as an amount of kick-back is proportional to the voltage level difference, the closer the term (Cgs−Ccomp) approaches to zero, the closer the amount of kick-back also approaches to zero so as to get higher display quality.

Next, several embodiments in relation to a detailed structure and operation of the kick-back compensation voltage supplier 600 will be explained.

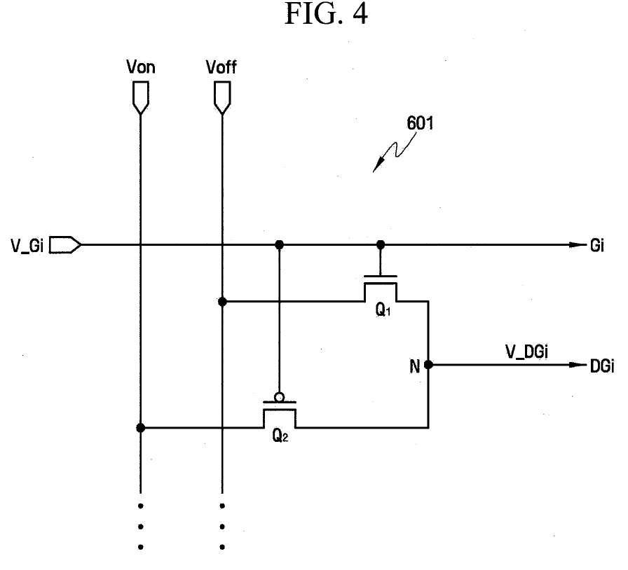

FIG. 4 is a circuit diagram to explain a kick-back compensation voltage supplier 601 according to an embodiment of the present invention.

The kick-back compensation voltage supplier 601 represents a part of the kick-back compensation voltage supplier 600 of FIG. 1, a circuitry correlating to the gate line Gi and the dummy gate line DGi.

The kick-back compensation voltage supplier 601 includes a first switching element Q1 and a second switching element Q2.

A gate electrode of the first switching element Q1 is connected to the gate line Gi. When the gate-on voltage Von is applied to the gate line Gi, the first switching element Q1 is turned on, and the gate-off voltage Voff is supplied to the dummy gate line DGi.

A gate electrode of the second switching element Q2 is connected to the gate line Gi. When the gate-off voltage Voff is applied to the gate line Gi, the second switching element Q2 is turned on, and the gate-on voltage Von is applied to the dummy gate line DGi.

The first and second switching elements Q1 and Q2 may be thin film transistors. Also, the first switching element Q1 may be an N-MOS transistor and the second switching element Q2 may be a P-MOS transistor.

By using the above structure, the kick-back compensation voltage V_DGi complimentary to the gate on/off voltage V_Gi is applied to the dummy gate line DGi through a node N.

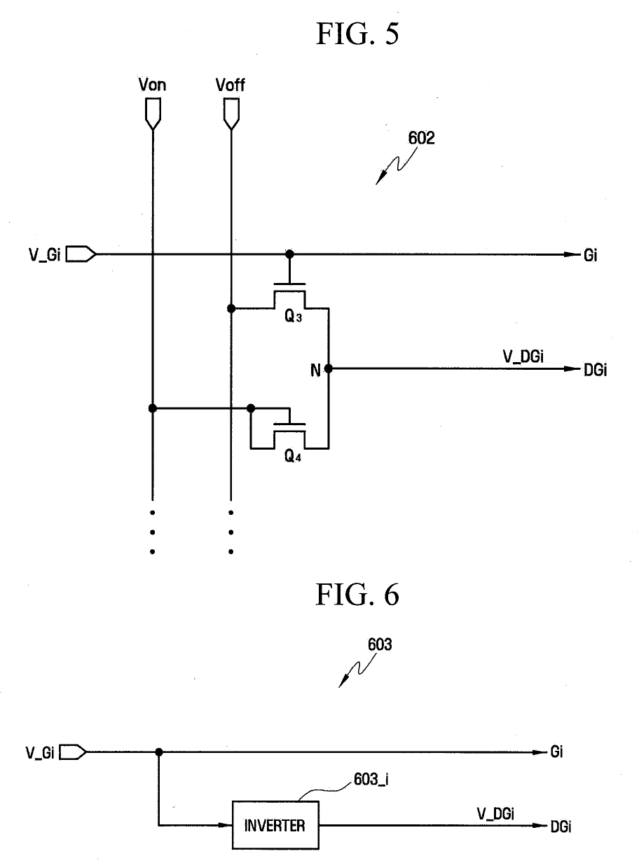

FIG. 5 is a circuit diagram to explain a kick-back compensation voltage supplier 602 according to another embodiment of the present invention.

The same reference numbers are used for some elements having the same functions as the corresponding elements in FIG. 4, and detailed explanation of them is omitted.

The kick-back compensation voltage supplier 602 includes a third switching element Q3 and a forth switching element Q4.

A gate electrode of the third switching element Q3 is connected to the gate line Gi. When the gate-on voltage Von is supplied to the gate line Gi, the third switching element Q3 is turned on, and the gate-off voltage Voff is applied to the dummy gate line DGi.

A gate electrode of the forth switching element Q4 is connected to its drain electrode to form a diode. When the gate-on voltage Von is applied to the gate electrode and the drain electrode of the forth switching element Q4, the forth switching element Q4 is turned on, the gate-on voltage Von is applied to the dummy gate line DGi.

In this embodiment, as the gate-on voltage Von is always applied via the forth switching element Q4, it is preferable that conductance of the switching element Q3 is larger than that of the switching element Q4, in order to apply the gate-off voltage Voff to the dummy gate line DGi when the third switching element Q3 is turned on. For example, in case that the third and forth switching elements are thin film transistors, it is preferable that a ratio of channel width to channel length W/L of the third switching element Q3 is larger than that of the forth switching element Q4.

The third and forth switching elements may be both N-MOS transistors. In this case, the third and forth switching elements can be formed on the first substrate 100 with the pixel transistor Qp during a thin film processes using amorphous silicon. Also, the gate driving circuit 400 can be also formed with the third and forth switching elements during the same processes.

FIG. 6 is a circuit diagram to explain a kick-back compensation voltage supplier 603 according to another embodiment of the present invention.

The same reference numbers are used for some elements having the same functions as the corresponding elements in FIG. 4, and a detailed explanation of the elements is omitted.

The kick-back compensation voltage supplier 603 includes a inverter 603_{—}i.

The inverter 603_{—}i inverts the gate on/off voltages V_Gi applied to the gate line Gi, and applies the inverted voltages to the dummy gate line DGi as the kick-back compensation voltages V_DGi.

The inverter 603_{—}i may be a digital logic circuit or analog logic circuit that functions to invert input signals.

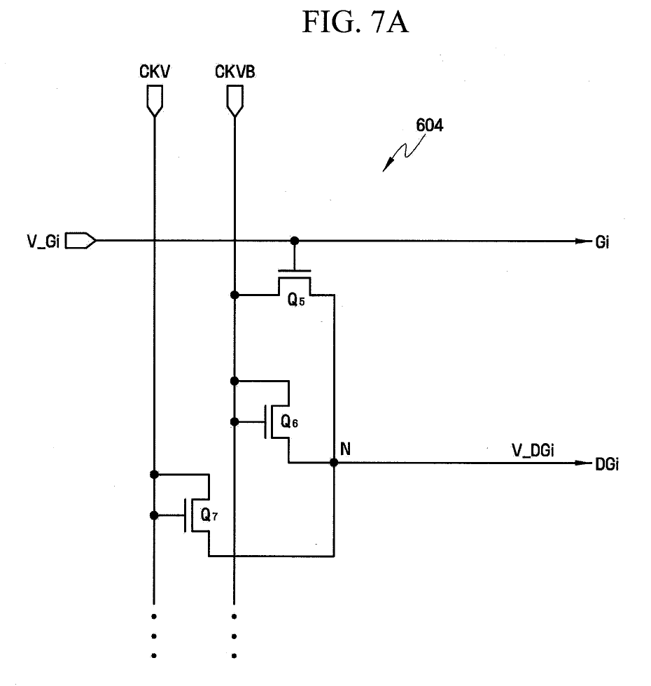

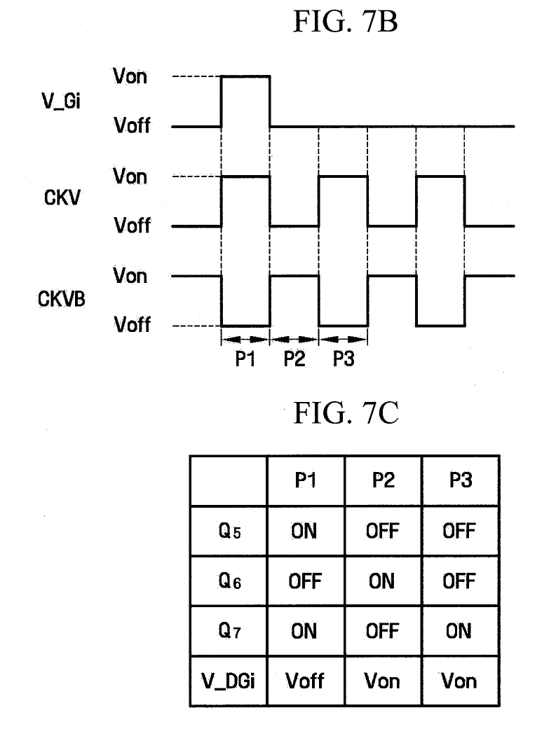

FIG. 7A is a circuit diagram for explaining a kick-back compensation voltage supplier 604 according to another embodiment of the present invention, FIG. 7B is a timing diagram for explaining the kick-back compensation voltage supplier 604 in FIG. 7A, and FIG. 7C is a table for explaining the operation of the kick-back compensation voltage supplier 604 in FIG. 7A.

The same reference numbers are used for the same elements having the same functions as the corresponding elements in FIG. 4, and a detailed explanation of them has been omitted.

Referring to FIGS. 7A and 7B, the kick-back compensation voltage supplier 604 includes fifth to seventh switching elements Q5, Q6, Q7, and receives a clock signal CKV and a clock bar signal CKVB. Here, the clock signal CKV has a high-level period P1, P3 and a low-level period P2, and the clock bar signal CKVB has a phase apposite to the phase of the clock signal CKV. The gate-on voltage is applied to the gate line Gi in the high-level period Pl. The voltage level of the clock signal CKV may be the gate-on voltage at the high-level periods P1, P3, and the gate-off voltage at the low-level period P2.

In more detail, referring to FIG. 7A through 7C, at a first high-level period P1, the gate-on voltage is applied to the gate line Gi, and the clock signal CKV is at a high level, for example the gate-on voltage Von, the clock bar signal CKVB is at a low level, for example the gate-off voltage Voff. Therefore, the fifth switching element Q5 is turned on and applies the clock bar signal CKVB to the output node N. That is, the fifth switching element Q5 applies the gate-off voltage to the output node N in the first high-level period P1. The sixth switching element Q6 is turned off. The seventh switching element Q7 is turned on, and applies the clock signal CKVB to the output node N. That is, the sixth switching element Q7 applies the gate-on voltage to the output node N at a first high-level period P1. Here, it is preferable that the conductance of the fifth switching element Q5 is larger than that of the switching elements Q6 and Q7, in order to apply the gate-off voltage Voff to the dummy gate line DGi. For example, in case that the fifth to seventh switching elements Q5, Q6, Q7 are thin film transistors, it is preferable that the ratio of channel width to channel length W/L of the fifth switching element Q5 is larger than those of the sixth and seventh switching elements Q6 and Q7. That is, the voltage level of the dummy gate line V_DGi is the gate-off voltage Voff in the first high-level period P1.

Next, in a first low-level period P2, the gate-off voltage is applied to the gate line Gi, and the clock signal CKV is at a low level, for example, the gate-off voltage Voff, and the clock bar signal CKVB is at a high level, for example, the gate-on voltage Von. Therefore, the fifth switching element Q5 is turned off. The sixth switching element Q6 is turned on, and applies the clock bar signal CKVB to the output node N. That is, the sixth switching element Q6 applies the gate-on voltage to the output node N at a first low-level period P2. The seventh switching elements Q7 is turned off. Therefore, the voltage level of the dummy gate line V_DGi is the gate-on voltage Von in the first low-level period P2.

Next, in a second high-level period P3, the gate-off voltage Voff is applied to the gate line Gi, and the clock signal CKV is at a high level, for example, the gate-on voltage Von, and the clock bar signal CKVB is at a low level, for example the gate-off voltage Voff. Therefore, the fifth and sixth switching elements Q5 and Q6 are turned off. The seventh switching element Q7 is turned on and applies the clock signal to the output node N. Therefore, the voltage level of the dummy gate line V_DGi is the gate-on voltage Von at the second high-level period P3 Therefore, the kick-back compensation voltage supplier 604 generates the kick-back compensation voltage V_DGi of which the phase is apposite to that of the voltage V_Gi applied to the gate line Gi, and applies the kick-back compensation voltage V_DGi to the dummy gate line DG_i, as shown in FIG. 3

Next, another condition to maximize the kick-back compensation effect, in addition to the kick-back compensation voltage supplier 600-604 above is explained.

Returning to Equation 4, if Cgs=Ccomp, then V_PE′−V_PE″=0. Therefore, the voltage level V_PE of the pixel electrode PE is kept constant around t3 and voltage draw-down does not occur.

Consequently, if the kick-back compensation voltage V_DGi complimentary to the gate on/off voltage Von/Voff is applied to the dummy gate line DGi, and the compensation capacitance Ccomp is the same as the parasite capacitance Cgs, occurrence of the kick-back phenomenon is prevented and display quality improves.

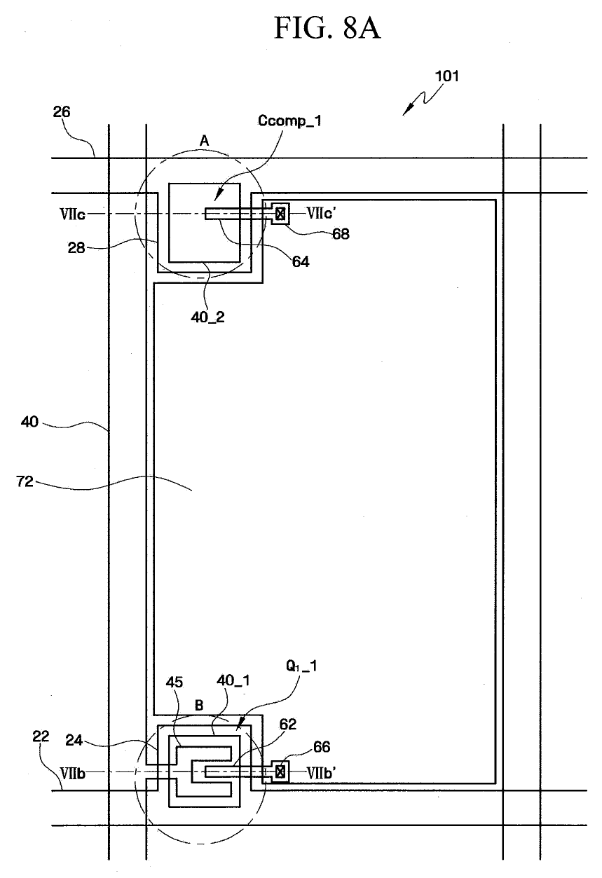

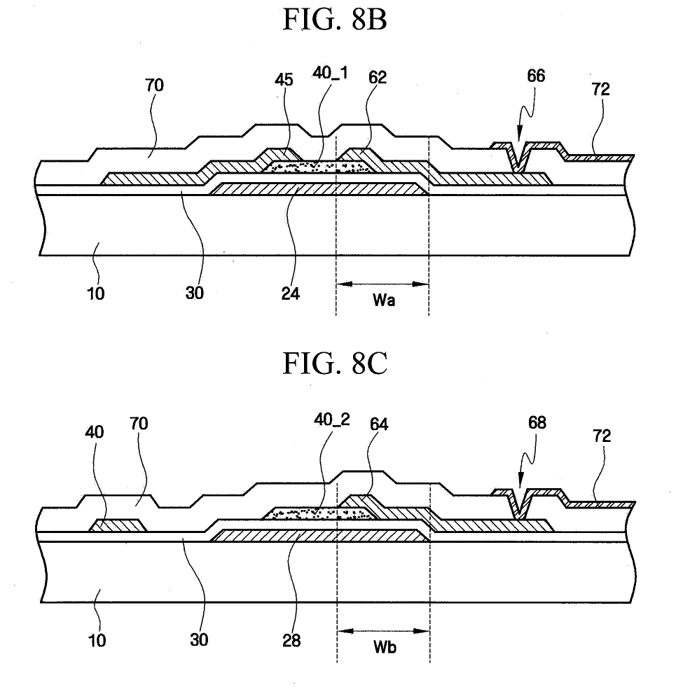

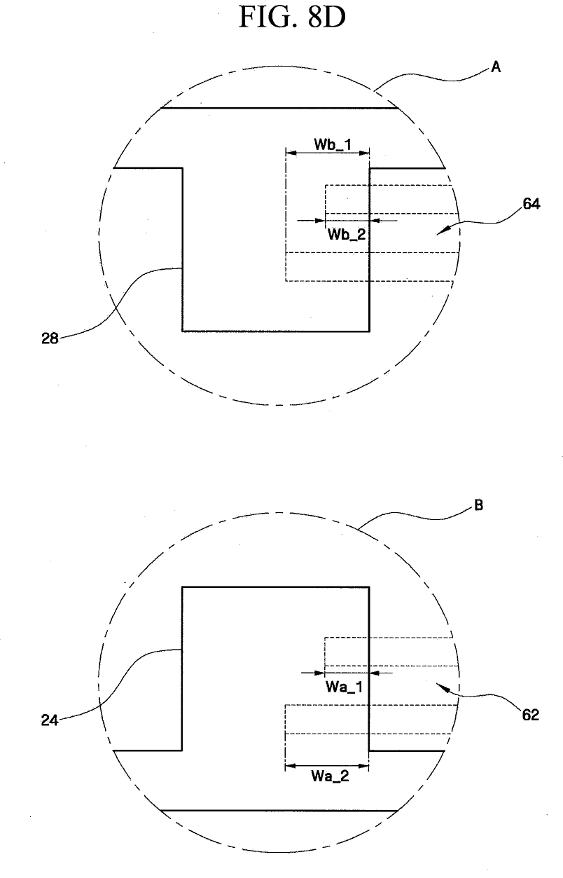

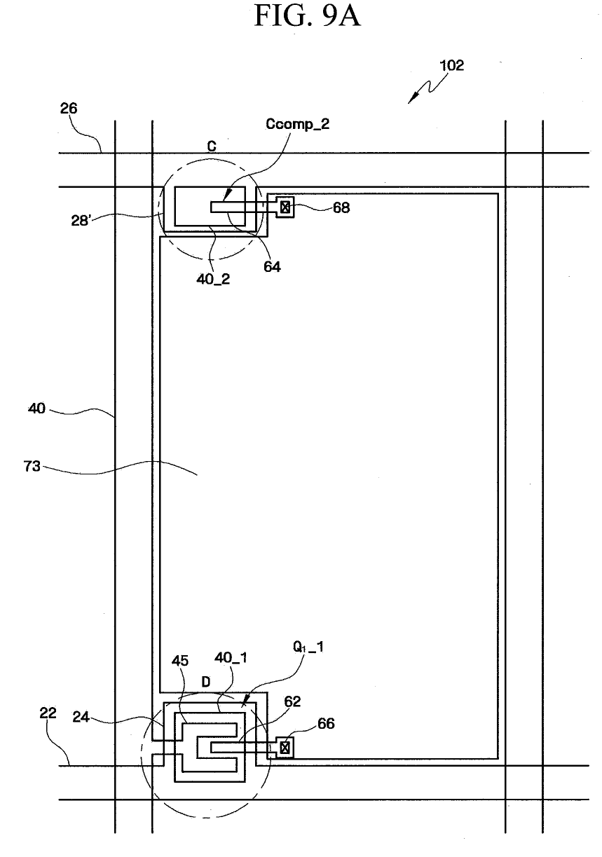

Several embodiments in relation to some pixel structures to meet the equation Cgs=Ccomp will be explained with reference to FIGS. 8A-10B.

FIG. 8A is a layout for explaining a first substrate 101 of an LCD according to another embodiment of the present invention, FIG. 8B is a sectional view taken along VIIb-VIIb′ of FIG. 8A, FIG. 8C is a sectional view taken along VIIc-VIIc′ of FIG. 8A, and FIG. 8D is an enlarged view of the areas A and B of FIG. 8A. Some elements, for example semiconductor patterns, are not showed in FIG. 8D for convenience.

The first substrate 101 includes a gate line 22 formed on a insulating substrate 10, a data line 42, a pixel transistor Qp_1, a pixel electrode 72, a dummy gate line 26, and a compensation capacitor Ccomp_1.

The insulating substrate 10 is made of transparent material with heat-resistance, for example, plastic or glass.

The gate line 22 is formed on the insulating substrate 10 and delivers the gate on/off voltage.

The gate line 22 is made of material such as aluminum or its alloy, silver or its alloy, copper or its alloy, molybdenum or its alloy, chromium or its alloy, titanium or its alloy, and tantalum or its alloy. The gate line 22 may be made of a multi-layered structure comprising at least two layers each having different materials frome the above mentioned group of materials.

A portion of the gate line 22 forms a gate electrode 24, which constitutes three components of the pixel transistor Qp_1 with a source electrode 62 and a drain electrode 45.

Though not shown in the figures, a storage line including a storage electrode may be formed independently of the gate line 22. The storage electrode overlaps with a pixel electrode 72 and forms a storage capacitance. The storage capacitance may be formed between a portion of the gate line 22 and a portion of the pixel electrode 72 overlapped with the portion of the gate line 22.

A dummy gate line 26 is formed on the same layer as the gate line 22.

The kick-back compensation voltage Vcomp complimentary to the gate on/off voltage Von/Voff is applied to the dummy gate line 26.

A portion of the dummy gate line 26 forms a dummy gate electrode 28, which constitutes a compensation capacitance Ccomp_1 with a dummy source electrode 64.

Over the insulating substrate 10, the gate line 22 and the dummy gate line 26, a gate insulator 30 made of material such as silicon oxide or silicon nitride is formed.

Active patterns 40_1 and 40_2 made of hydrogenated amorphous silicon, poly-silicon or conductive organic material are formed on the gate insulator 30.

The active patterns 40_1, 40_2 overlap the gate electrode 24 and the dummy gate electrode 28. The active pattern 40_1 above the gate electrode 24 overlaps with at least a portion of the source electrode 62 and the drain electrode 45, and the active pattern 40_2 above the dummy gate electrode 28 overlaps with at least a portion of the dummy source electrode 64.

Though not shown, ohmic contact patterns, made of material such as amorphous silicon doped with n type or p type impurities are formed on the active patterns 40_1 and 40_2.

The data line 42 is formed over the gate insulator 30 and the active patterns 40_1 and 40_2. A portion of the data line 42 forms the drain electrode 45.

The data line 42 is made of a material such as aluminum or its alloy, silver or its alloy, copper or its alloy, molybdenum or its alloy, chromium or its alloy, titanium or its alloy, and tantalum or its alloy. The data line 42 may be made of a multi-layered structure comprising at least two layers each having different material from the above mentioned group of materials.

The source electrode 62 and the dummy source electrode 64 are formed on the same layer as the data line 42. The source electrode 62 overlaps over at least a portion of the active pattern 40_1 and is spaced apart from the drain electrode 45. The dummy source electrode 64 overlaps over at least a portion of the active pattern 40_2.

The source electrode 62 and the gate electrode 24 overlap each other to form a parasite capacitance Cgs, and the compensation capacitance Ccomp_1 is formed to have the same value as the parasite capacitance Cgs.

For example, an overlapped area of the gate electrode 24 and the source electrode 62 may be set to be the same as an overlapped area of the dummy gate electrode 24 and the dummy source electrode 64. Also, an overlapped length Wa of the gate electrode 24 and the source electrode 62 may be set to be the same as an overlapped length Wb of the dummy gate electrode 28 and the dummy source electrode 64.

The source electrode 62 and the dummy source electrode 64 may be formed in the same patterning processes, and the compensation capacitance Ccomp_1 can be set to be the same as the parasite capacitance Cgs, even if a misalignment of a patterning mask happens.

As shown by FIG. 8A, the source electrode 62 and the dummy source electrode 64 are each formed in the same direction.

As shown by FIG. 8D, the overlapped length of the gate electrode 24 and the source electrode 62 can be Wa_1 or Wa_2 according to the misalignment. The overlapped length of the dummy gate electrode 28 and the dummy source electrode 64 can be Wb_1 or Wb_2 according to the misalignment.

In the event that the overlapped length is Wa_1, the overlapped length of dummy gate electrode 28 and the dummy source electrode 64 is Wb_1. In the event that the overlapped length is Wa_2, the overlapped length of dummy gate electrode 28 and the dummy source electrode 64 is Wb_2.

Therefore, even if the misalignment happens, the overlapped length of the source electrode 62 and the gate electrode 24, and the overlapped length of the dummy source electrode 64 and the dummy gate electrode 28 shift with the same displacement, so that the parasitic capacitance Cgs is set to be the same as the compensation capacitance Ccomp_1 independently of the misalignment.

Over the data line 42, the source electrode 62, dummy source electrode 64 and the drain electrode 45, a passivation layer 70 made of material such as silicon oxide or silicon nitride is formed. The passivation layer 70 may be made of organic material such as acryl. Also, the passivation layer 70 may be formed of a multi-layered structure such as silicon nitride and organic layers.

The source electrode 62 is connected to the pixel electrode 72 through a contact hole 66, and the dummy source electrode 64 is connected to the pixel electrode 72 through a contact hole 68.

The pixel electrode 72 is formed of a transparent conductive material such as ITO (Indium Tin Oxide) or IZO (Indium Zinc Oxide).

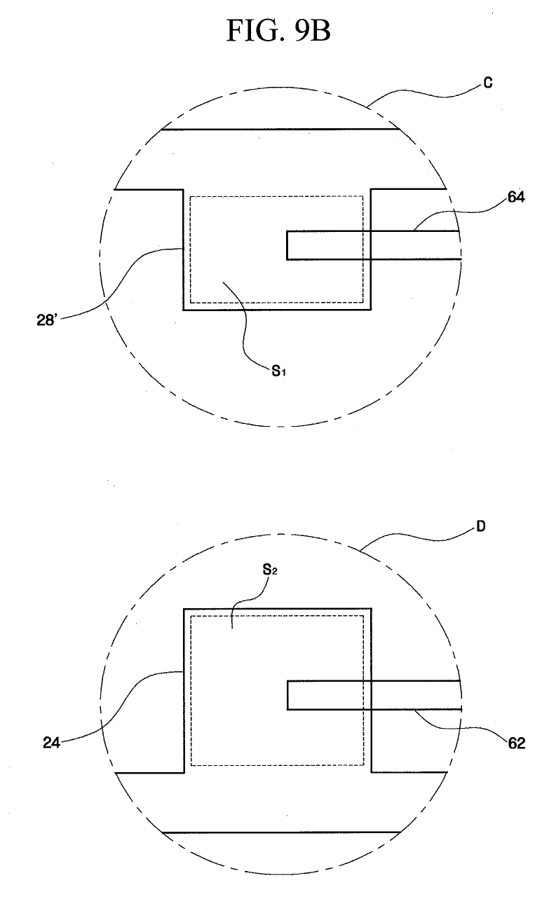

Another embodiment of the present invention will be explained with reference to FIGS. 9A and 9B.

FIG. 9A is a layout for explaining a first substrate 102 of an LCD according to another embodiment of the present invention, FIG. 9B is an enlarged view of the areas C and D of FIG. 9A. Some elements, for example semiconductor layers, are not shown in FIG. 9B for convenience. Use of the same reference symbols in different figures indicates similar or identical items, the details of which will not be explained.

As shown by FIG. 9A, the area of a dummy gate electrode 28′ is smaller than the area of the gate electrode 24, so that the area of a pixel electrode 73 can be broadened.

As a compensation capacitance Ccomp_2 is formed between the dummy gate electrode 28′ and the dummy source electrode 64, a component similar to the drain electrode 45 of the pixel transistor Qp_1 is not needed for the compensation capacitance Ccomp_2. Therefore, the dummy gate electrode 28′ can be formed to have the smallest overlapping area with the dummy source electrode 64.

As shown by FIG. 9B, area S1 of the dummy gate electrode 28′ is smaller than area S2 of the gate electrode 24. Therefore, the area of the pixel electrode 73 can be broadened so as to enhance transmittance.

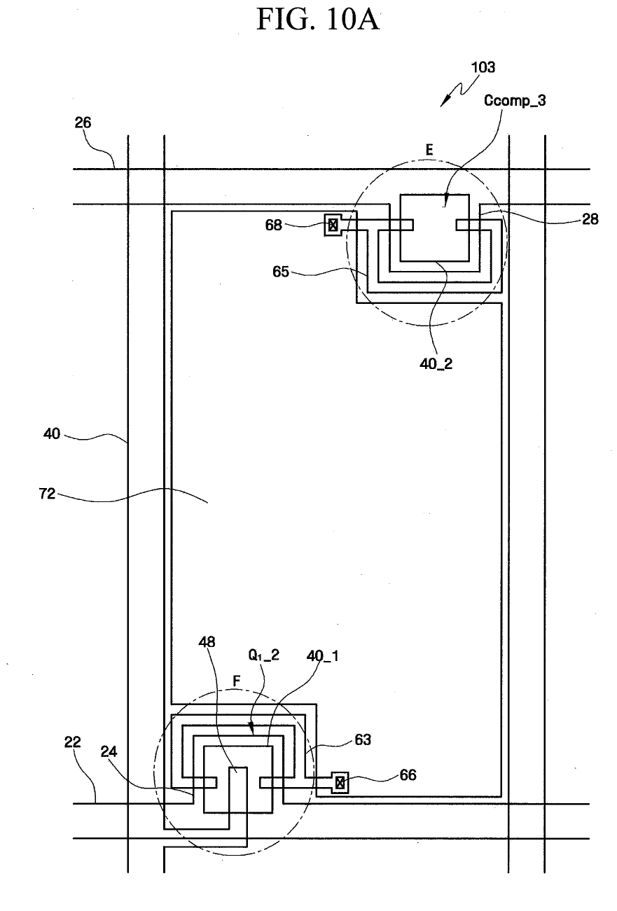

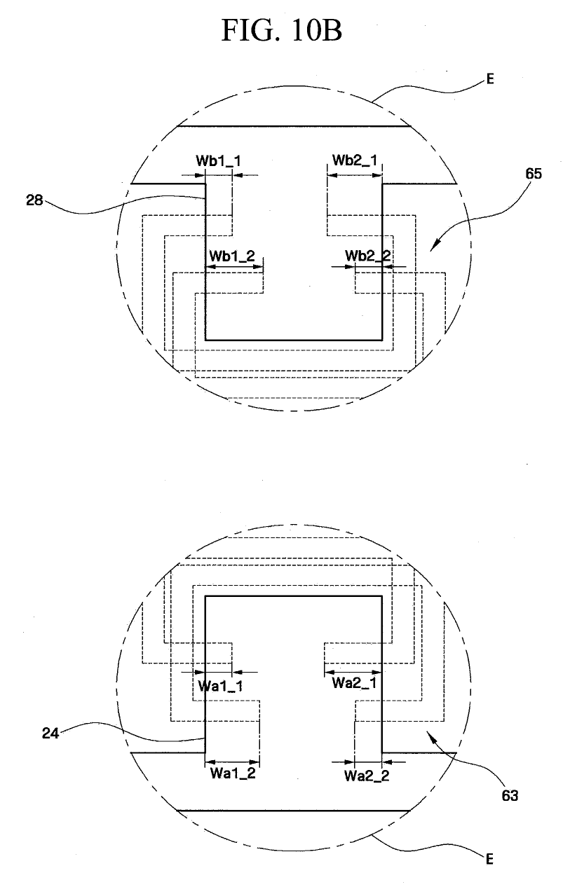

Another embodiment of the present invention will be explained below with reference to FIGS. 10A and 10B.

FIG. 10A is a layout for explaining a first substrate 103 of an LCD according to another embodiment of the present invention, FIG. 10B is an enlarged view of the areas E and F of FIG. 10A. Some elements, for example semiconductor patterns, are not showed in FIG. 10B for convenience. Use of the same reference symbols in different figures indicates similar or identical items, the details of which will not be explained.

Referring to FIG. 10A, a source electrode 63 is formed to extend from outside to a drain electrode 48 through opposing two sides of the gate electrode 24.

A dummy source electrode 65, having similar shape to the source electrode 63, is formed to extend from outside to inner side through opposing two sides of the dummy gate electrode 28.

As shown by FIG. 10B, the overlapped length of the gate electrode 24 and the source electrode 63 can be Wa1_1/Wa2_1 or Wa1_2/Wa2_2 according to the misalignment. The overlapped length of the dummy gate electrode 28 and the dummy source electrode 65 can be Wb1_1/Wb2_1 or Wb1_2/Wb2_2 according to the misalignment.

In the event that the overlapped length of the gate electrode 24 and the source electrode 63 is Wa1_1/Wa2_1, the overlapped length of dummy gate electrode 28 and the dummy source electrode 65 is Wb1_1/Wb2_1. In the event that the overlapped length of the gate electrode 24 and the source electrode 63 is Wa1_2/Wa2_2, the overlapped length of dummy gate electrode 28 and the dummy source electrode 65 is Wb1_2/Wb2_2.

Therefore, even if the misalignment happens in any direction, the overlapped length of the source electrode 63 and the gate electrode 24, and the overlapped length of the dummy source electrode 65 and the dummy gate electrode 28 shift with the same displacement, so that the parasitic capacitance Cgs is set to be the same as the compensation capacitance Ccomp_3.

According to the above embodiments, occurrence of the kick-back phenomenon is prevented and display quality improves.

The above-described embodiments of the present invention are merely meant to be illustrative and not limiting. It will thus be obvious to those skilled in the art that various changes and modifications may be made without departing from this invention in its broader aspects. Therefore, the appended claims encompass all such changes and modifications as fall within the true spirit and scope of this invention.

What is claimed is:

1. A display device comprising:
a gate line delivering a gate on/off voltage;
a data line insulated from the gate line;
a pixel transistor including a gate electrode connected to the gate line, a drain electrode connected to the data line and a source electrode spaced apart from the drain electrode;
a pixel electrode connected to the source electrode;
a dummy gate line delivering a kick-back compensation voltage complimentary to the gate on/off voltage; and
a compensation capacitance formed between a dummy gate electrode connected to the dummy gate line and a dummy source electrode connected to the pixel electrode.

2. The display device of claim 1, wherein an overlap area of the dummy source electrode and the dummy gate electrode is substantially the same as an overlap area of the source electrode and the gate electrode.

3. The display device of claim 1, wherein the source electrode extends over the gate electrode to a first direction and the dummy source electrode extends over the dummy gate electrode to the first direction.

4. The display device of claim 3, wherein an overlap area of the dummy source electrode and the dummy gate electrode is substantially the same as an overlap area of the source electrode and the gate electrode.

5. The display device of claim 1, wherein the source electrode extends from outside of the gate electrode to the drain electrode through opposing two sides of the gate electrode and the dummy source electrode extends from outside of the dummy gate electrode to inside of the dummy gate electrode through opposing two sides of the dummy gate electrode.

6. The display device of claim 5, wherein an overlap area of the dummy source electrode and the dummy gate electrode is substantially the same as an overlap area of the source electrode and the gate electrode.

7. The display device of claim 1, wherein the compensation capacitance is substantially the same as a parasite capacitance formed between the source electrode and the gate electrode.

8. The display device of claim 1, wherein an area of the dummy gate electrode is smaller than an area of the gate electrode.

9. The display device of claim 1, further comprising a storage line including a storage electrode.

10. The display device of claim 1, further comprising a gate driving circuit applying the gate on/off voltage to the gate line and a kick-back compensation voltage supplier applying the kick-back compensation voltage to the dummy gate line.

11. The display device of claim 10, wherein the kick-back compensation voltage supplier applies the gate-off voltage to the dummy gate line when the gate-on voltage is applied to the gate line and applies the gate-on voltage to the dummy gate line when the gate-off voltage is applied to the gate line.

12. The display device of claim 11, wherein the kick-back compensation voltage supplier includes a first switching element and a second switching element, and
wherein the first switching element is turned on with the gate-on voltage to deliver the gate-off voltage to the dummy gate line and the second switching element is turned on with the gate-off voltage to deliver the gate-on voltage to the dummy gate line.

13. The display device of claim 11, wherein the kick-back compensation voltage supplier includes a first N-MOS transistor and a second N-MOS transistor, and
wherein the first N-MOS transistor is turned on with the gate-on voltage to deliver the gate-off voltage to the dummy gate line and the second N-MOS transistor operates as a diode with the gate-on voltage to deliver the gate-on voltage to the dummy gate line.

14. The display device of claim 11, wherein when a clock signal has a high-level period and a low-level period, a clock bar signal has a phase apposite to the phase of the clock signal, and the gate-on voltage is applied to the gate line during the high-level period of the clock signal,
the kick-back compensation voltage supplier includes a first switching element, a second switching element, and a third switching element, wherein the first switching element is turned on with the gate-on voltage to apply the clock bar signal to the dummy gate line and the second switching element is diode-connected and applies the clock signal to the dummy gate line, and the third is diode-connected and applies the clock bar signal to the dummy gate line.

15. The display device of claim 13, wherein the voltage level of the clock signal is the gate-on voltage at the high-level period, and the gate-off voltage at the low-level period.

16. The display device of claim 10, wherein the kick-back compensation voltage supplier includes a first switching element and a second switching element, and
wherein the first switching element is turned on with the gate-on voltage to deliver the gate-off voltage to the dummy gate line and the second switching element is turned on with the gate-on voltage to deliver the gate-on voltage to the dummy gate line.

17. A display device comprising:
a display part including a gate line delivering a gate on/off voltage, a data line insulated to the gate line, a pixel transistor including a gate electrode connected to the gate line, a drain electrode connected to the data line and a source electrode spaced apart from the drain electrode, a pixel electrode connected to the source electrode;
a gate driving circuit applying a gate on/off voltage to the gate line;
a kick-back compensation voltage supplier applying a kick-back compensation voltage complementary to the gate on/off voltage to the display part; and
a data driving circuit applying a image data to the data line.

18. The display device of claim 17, wherein the display part includes a dummy gate line delivering the kick-back compensation voltage complimentary to the gate on/off voltage and a compensation capacitance formed between a dummy gate electrode connected to the dummy gate line and a dummy source electrode connected to the pixel electrode.

19. The display device of claim 17, wherein when a clock signal has a high-level period and a low-level period, and a clock bar signal has a phase apposite to the phase of the clock signal, and the gate-on voltage is applied to the gate line during the high-level period of the clock signal,
the kick-back compensation voltage supplier includes a first switching element, a second switching element, and a third switching element, wherein the first switching element is turned on with the gate-on voltage to apply the clock bar signal to the dummy gate line and the second switching element is diode-connected and applies the clock signal to the dummy gate line, and the third switching element is diode-connected and applies the clock bar signal to the dummy gate line.

20. The display device of claim 19, wherein the voltage level of the clock signal is the gate-on voltage at the high-level period and the gate-off voltage at the low-level period.
